(19) United States
(12) Patent Application Publication
(10) Pub. No.: US 2004/0035005 A1
(43) Pub. Date: Feb. 26, 2004

(54) Electrical pruning shears

(76) Inventors: Hai-Ing Huang, Sanchung City (TW); Hai-Su Huang, Sanchung City (TW)

Correspondence Address: Jackson Walker L.L.P., Suite 2100, 112 E. Pecan Street, San Antonio, TX, 78205, US

(21) Appl. No.: 10/641,993

(22) Filed: Aug. 15, 2003

(30) Foreign Application Priority Data
Aug. 26, 2002 (TW) 091213212

(51) Int. Cl. B26B 7/00

(52) U.S. Cl. 30/276

(57) ABSTRACT

An electrical pruning shears includes a motor received in the handle and a transmission assembly connected to the motor and having an axle securely connected to a front portion of the transmission assembly to connect to a cutting blade. A protection cover is provided to selectively cover the cutting blade for protection. A safety device is provided to the switch such that the movement of the switch is alternatively blocked for safety reason.

### BACKGROUND OF THE INVENTION

1. Field of the Invention

The present invention relates to an electrical pruning shears, and more particularly to an electrical pruning shears enabling the operator to operate the shears easily and with safety.

2. Description of Related Art

Pruning shears are essential equipment for florists when pruning the trees. The operator normally uses his palm to hold and operate the pruning shears. To those who occasionally trim the trees, holding the pruning shears with palms is still bearable. However, to those who need to constantly trim the trees, holding the pruning shears all day long would hurt the palm and sometimes even hurt the hand. Especially, when in spring times, burgeon are all over the trees. The operator will spend a great deal of time and effort trying to trim the unnecessary burgeon, which is quite a waste of time and effort.

To overcome the shortcomings, the present invention tends to provide an improved electrical pruning shears to mitigate the aforementioned problems.

### SUMMARY OF THE INVENTION

The primary objective of the present invention is to provide an improved electrical pruning shears having a rotatable blade to enable the operator to prune the trees easily, a protection cover movably mounted on the casing of the pruning shears to alternately cover the blade to protect the operator from damage and a safety device movably engaged with the switch so that the switch is protected from false movement.

Other objects, advantages and novel features of the invention will become more apparent from the following detailed description when taken in conjunction with the accompanying drawings.

### BRIEF DESCRIPTION OF THE DRAWINGS

FIG. 1 is perspective view of the electrical pruning shears of the present invention;

FIG. 2 is a schematic view showing the internal structure of the electrical pruning shears of the present invention;

FIGS. 3 and 4 are a schematic views showing the connection of the transmission assembly of the present invention;

FIG. 5 is a top plan view showing the relative position between the protection cover and the cutting blade;

FIGS. 6 and 7 are schematic views showing the movement of the protection cover relative to the cutting blade; and

FIGS. 8 and 9 are schematic views showing the movement of the safety device relative to the switch.

### DETAILED DESCRIPTION OF THE PREFERRED EMBODIMENT

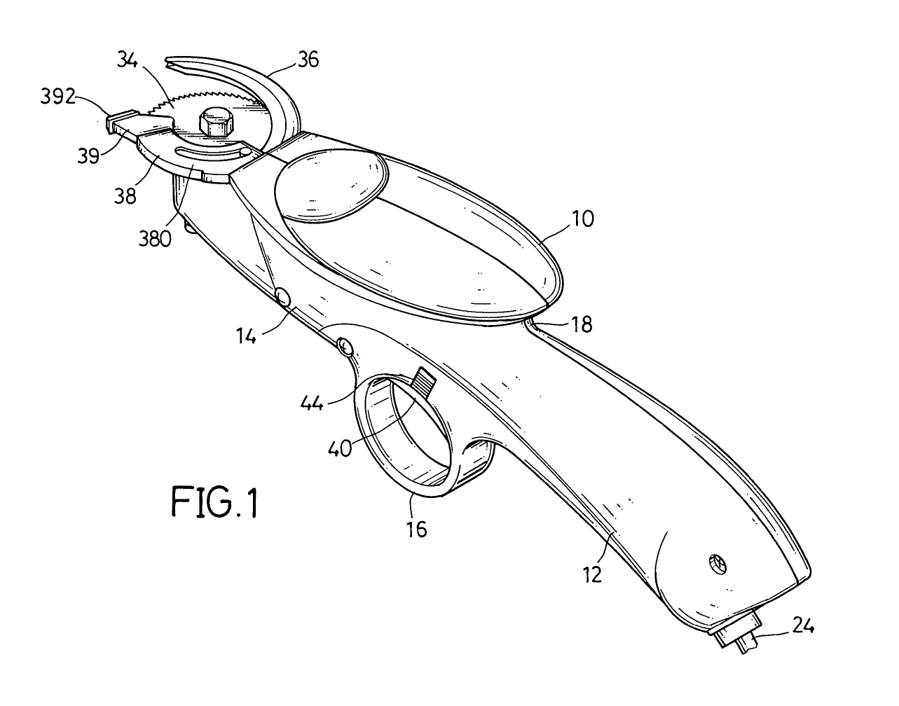

With reference to FIG. 1, the electrical pruning shears in accordance with the present invention has a casing (10) composed of a handle (12) and a body (14). A switch guard (16) is formed at a joint between the handle (12) and the body (14) and has a switch (40) movably received inside the switch guard (16). A cutting blade (34) is rotatably mounted at a front portion of the body (14).

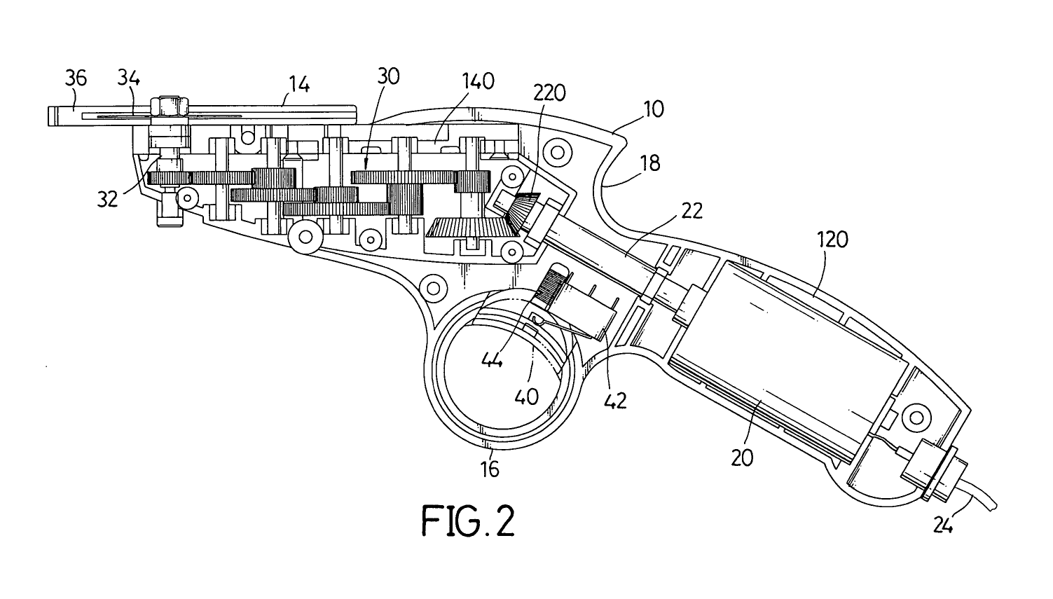

With reference to FIG. 2, it is noted that a motor (20) is received in a motor chamber (120) in the handle (12) and connected to a cable (24) for power supply. A transmission assembly (30) is received in a transmission chamber (140) in the body (14). The motor (20) has a motor shaft (22) extending out of the motor (22) and having a conical gear (220) fixedly mounted at a free end of the motor shaft (22) to engage with the transmission assembly (30). The transmission assembly (30) has an axle (32) rotatably connected to the transmission assembly (30) and fixedly connected to a center of the cutting blade (34) such that the cutting blade (34) is able to be rotated via the rotation of the axle (32). A recessed area (18) is formed in the casing (10) opposite to the switch guard (16) to receive the portion between the operator's thumb and the index finger.

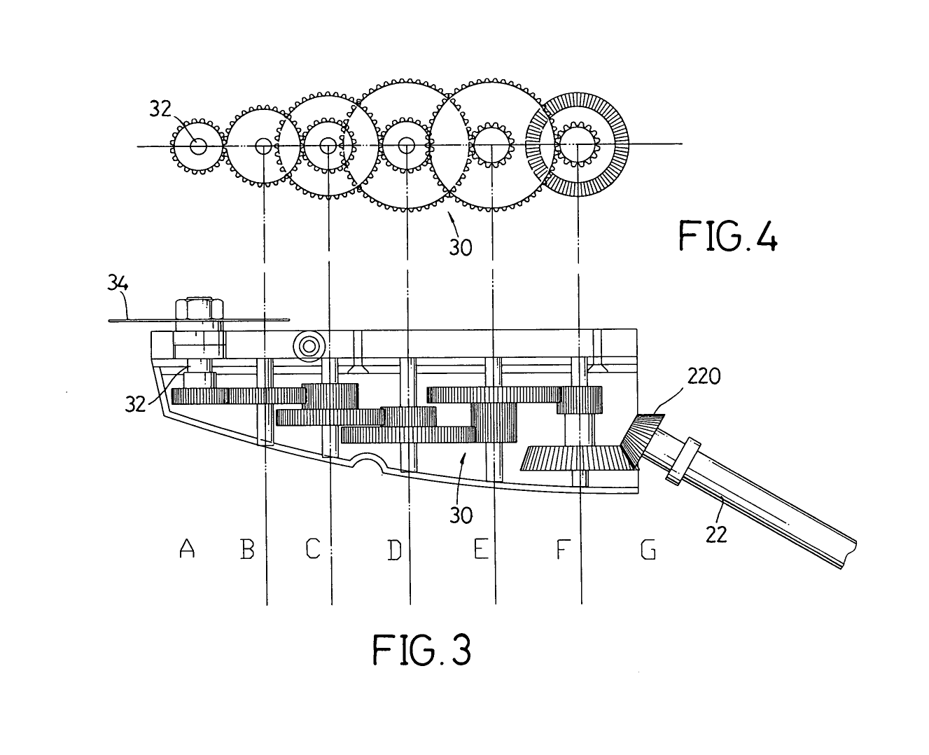

With reference to FIGS. 3 and 4, it is noted that the transmission assembly of the present invention has different configure and arrangement so that the arrangement shown in the drawings are only illustrative purpose only and forms no limitation to the scope of the invention.

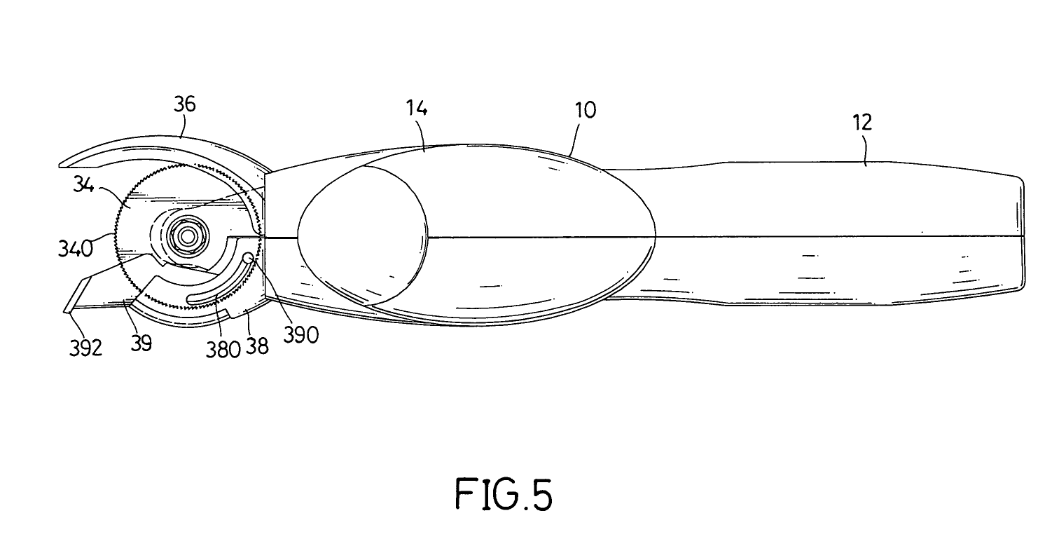

With reference to FIG. 5, the electrical pruning shears of the present invention has a protection cover composed of a fixed primary cover (36) extending out from one side of the distal end of the body (14) and a secondary cover (38) extending out from the other side of the distal end of the body (14). A movable cover (39) is received in the secondary cover (38) and has a projection (390) received in a slot (380) defined in the secondary cover (38).

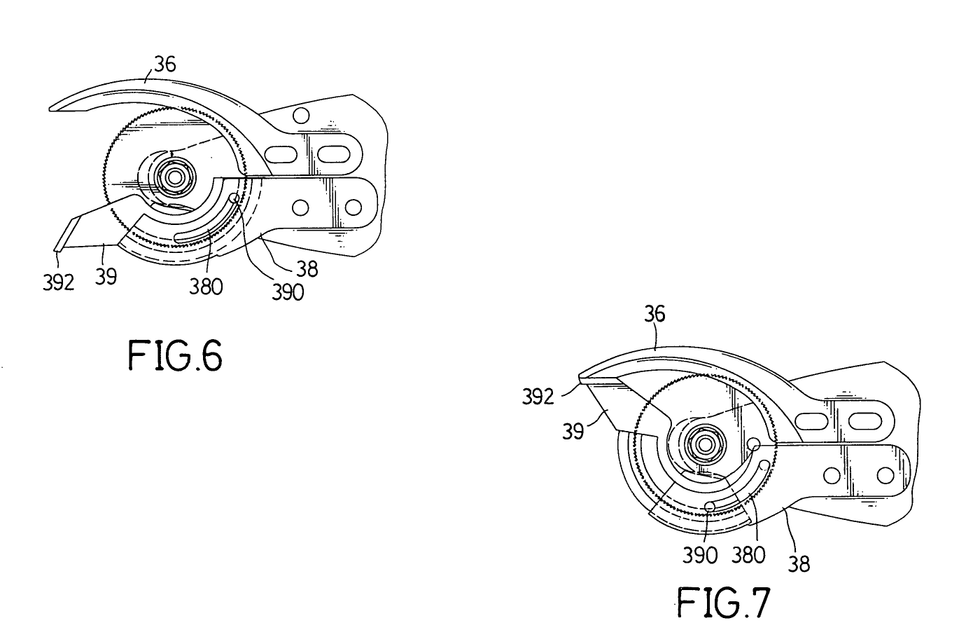

With reference to FIGS. 6 and 7, it is to be noted that when the cutting blade (34) is not in use, the operator is able to bold an extension (392) formed on an outer periphery of the movable cover (39) to encase the cutting blade (34) so as to protect the operator from damage.

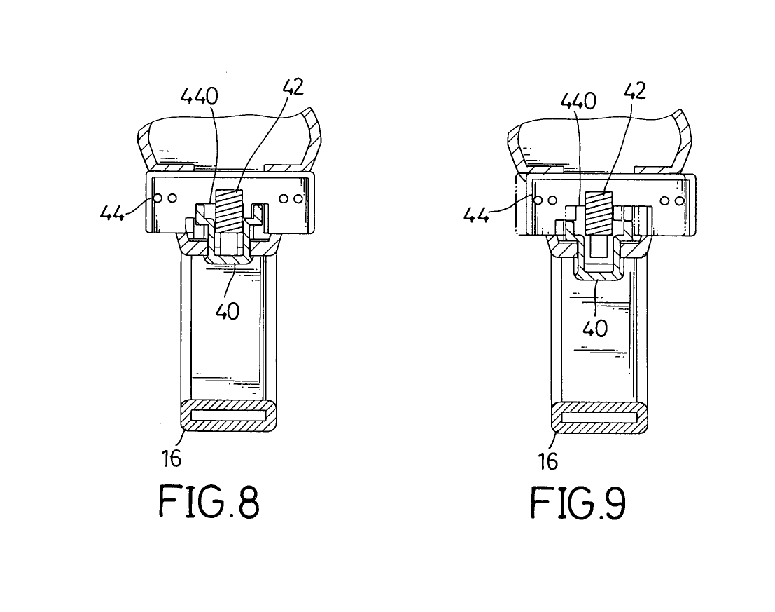

With reference to FIGS. 7 and 8, it is noted that the switch (40) is connected to a micro switch (42) so that everytime when the switch (40) is pressed, the micro switch (42) is activated to start the motor (20). Also, the switch (40) is limited by the safety device (44) which has a cutout (440) defined to correspond to the switch (40). Therefore, when the cutout (440) aligns with the switch (40), the switch (40) is able to be pressed and when the cutout (440) is not in alignment with the switch (40), the switch (40) is blocked to activate the motor (20). Therefore, the safety device (44) is able to protect the electrical pruning shears from false movement.

It is to be noted that the cable (24) may be connected to a battery (not shown) so that the operator is able to have the electrical pruning shears of the present invention around while carrying the battery. Also, the cable (24) may be connected to a wall outlet via an extension cable. That is to say, the operation of the pruning shears is very easy and able to save a lot of troubles for the operator.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An electrical pruning shears comprising:
a casing composed of a body with a transmission assembly received inside the body and a handle with a motor received in the handle and connected to a cable for power supply and the transmission assembly to drive the transmission assembly;
a cutting blade rotatably mounted at a front portion of the casing and connected to the transmission assembly to be driven by the transmission assembly; and
a switch movably mounted at a bottom portion of the casing to control activation of the motor,
whereby after the switch is pressed, movement of the motor drives the transmission assembly and the cutting blade.

2. The electrical pruning shears as claimed in claim 1, wherein the casing defines a transmission chamber to receive therein the transmission assembly and a motor chamber to receive therein the motor.

3. The electrical pruning shears as claimed in claim 2, wherein a switch guard is formed at a junction between the body and the handle to protect the switch therein.

4. The electrical pruning shears as claimed in claim 3, wherein a recessed area is formed opposite to the switch guard for receiving a portion of operator's hand.

5. The electrical pruning shears as claimed in claim 1, wherein the motor has a motor shaft extending out of the motor and a conical gear securely connected to a free end of the motor shaft to connect to the transmission assembly.

6. The electrical pruning shears as claimed in claim 4, wherein the motor has a motor shaft extending out of the motor and a conical gear securely connected to a free end of the motor shaft to connect to the transmission assembly.

7. The electrical pruning shears as claimed in claim 6, wherein the cutting blade is connected to the transmission assembly via an axle which is rotatably connected to a front portion of the transmission assembly.

8. The electrical pruning shears as claimed in claim 1, wherein a protection cover is provided at a front portion of the casing to alternatively cover the cutting blade.

9. The electrical pruning shears as claimed in claim 6, wherein a protection cover is provided at a front portion of the casing to alternatively cover the cutting blade.

10. The electrical pruning shears as claimed in claim 7, wherein a protection cover is provided at a front portion of the casing to alternatively cover the cutting blade.

11. The electrical pruning shears as claimed in claim 8, wherein the protection cover is composed of a primary cover extending out from one side of the front portion of the casing, a fixed secondary cover extending out from the other side of the front portion of the casing and a movable cover having a projection received in a slot defined in the fixed secondary cover such that the movable cover is able to cover the cutting blade when the cutting blade is not in use.

12. The electrical pruning shears as claimed in claim 9, wherein the protection cover is composed of a primary cover extending out from one side of the front portion of the casing, a fixed secondary cover extending out from the other side of the front portion of the casing and a movable cover having a projection received in a slot defined in the fixed secondary cover such that the movable cover is able to cover the cutting blade when the cutting blade is not in use.

13. The electrical pruning shears as claimed in claim 10, wherein the protection cover is composed of a primary cover extending out from one side of the front portion of the casing, a fixed secondary cover extending out from the other side of the front portion of the casing and a movable cover having a projection received in a slot defined in the fixed secondary cover such that the movable cover is able to cover the cutting blade when the cutting blade is not in use.

14. The electrical pruning shears as claimed in claim 1, wherein a safety device is provided to the switch to selectively determine movement of the switch.

15. The electrical pruning shears as claimed in claim 14, wherein the safety device has a cutout defined to selectively align with the switch such that when the cutout aligns with the switch, the switch is movable and when the cutout is not in alignment with the switch, the switch is immovable.
